(19) United States
(12) Patent Application Publication
(10) Pub. No.: US 2024/0170634 A1
(43) Pub. Date: May 23, 2024

(54) METHOD FOR MANUFACTURING BATTERY ELECTRODE

(71) Applicants: Hyundai Motor Company, Seoul (KR); Kia Corporation, Seoul (KR)

(72) Inventors: Han Nah SONG, Ansan-si (KR); Yong II CHO, Seoul (KR); Hyun Jin KIM, Dalseo-gu (KR); Chan Bum PARK, Suwon-si (KR); Hyeon Ha LEE, Anyang-si (KR); Geun Ho CHOI, Suwon-si (KR)

(21) Appl. No.: 18/310,024

(22) Filed: May 1, 2023

(30) Foreign Application Priority Data
Nov. 22, 2022 (KR) 1020220156922

(51) Int. Cl. H01M 4/04

(52) U.S. Cl. CPC H01M 4/0411; H01M 4/0416

(57) ABSTRACT

The present disclosure relates to a battery, and more particularly to a battery electrode. According to some implementations of the present disclosure, a method for manufacturing a battery electrode includes: forming a mixture of a polymer powder and an active material into a fiber; weaving the fiber into a woven film; and carbonizing the woven film.

### CROSS-REFERENCE TO RELATED APPLICATION

This application claims under 35 U.S.C. § 119(a) the benefit of priority to Korean Patent Application No. 10-2022-0156922 filed on Nov. 22, 2022, the entire contents of which are incorporated herein by reference.

### TECHNICAL FIELD

The present disclosure relates to a battery and, more particularly, to a battery electrode.

### BACKGROUND

Recently, the use of secondary batteries, such as electronic devices, electric vehicles, energy storage devices, or the like, is expanding. A lithium ion battery is one of the most widely used types of secondary batteries.

Electrodes of these batteries may be manufactured through a wet process. Specifically, in the wet process, a slurry is manufactured by preparing a powder in which an electrode active material, a binder, and a conductive material are mixed and mixing the powder with a solvent. Then the slurry is coated on a substrate and dried with hot air. Additionally, the dried material is rolled to improve the density of an electrode mixture.

### SUMMARY OF THE DISCLOSURE

An object of the present disclosure is to provide an electrode manufacturing method capable of manufacturing a battery electrode in a dry method.

The object of the present disclosure is not limited to the object mentioned above, and other objects not mentioned will be clearly understood to an ordinary person skilled in the art to which the present disclosure pertains from the following description.

The characteristics of the present disclosure for achieving the object of the present disclosure as described above and performing the characteristic functions of the present disclosure described later are as follows.

According to some implementations of the present disclosure, a method for manufacturing a battery electrode includes forming a mixture of a polymer powder and an active material into a fiber; weaving the fiber into a woven film; and carbonizing the woven film.

According to some implementations of the present disclosure, a method for manufacturing a battery electrode includes mixing a polymer powder and an active material; obtaining a fiber by extruding the mixture of the polymer powder and the active material, which has been obtained by mixing; weaving the fiber into a woven film; and carbonizing the woven film through a carbonization device.

According to the present disclosure, the electrode manufacturing method capable of manufacturing a battery electrode in a dry method is provided.

Effects of the present disclosure are not limited to that described above, and other effects not mentioned will be clearly recognized by an ordinary skilled person from the description below.

### BRIEF DESCRIPTION OF THE DRAWINGS

FIG. 1 shows an example flow chart of a method for manufacturing a battery electrode according to the present disclosure.

FIG. 2 illustrates exemplary mixing and extrusion processes according to the manufacturing method of the present disclosure.

FIGS. 3A to 3C illustrate an example weaving process according to the manufacturing method of the present disclosure.

FIG. 4 illustrates an example carbonization process according to the manufacturing method of the present disclosure.

FIG. 5 illustrates an example process for manufacturing an electrode according to the manufacturing method of the present disclosure.

### DETAILED DESCRIPTION

Specific structural or functional descriptions presented in the implementations of the present disclosure are merely exemplified for the purpose of explaining implementations according to the concept of the present disclosure, and the implementations according to the concept of the present disclosure may be implemented in various forms. In addition, the present disclosure should not be construed as being limited to the implementations described in this specification, and should be understood to include all modifications, equivalents, or substitutes included in the spirit and technical scope of the present disclosure.

Hereinafter, the present disclosure will be described in detail with reference to the accompanying drawings.

The present disclosure relates to a method for manufacturing an electrode, the method capable of making a battery electrode with a thick film and manufacturing a low-resistance electrode without a binder. In order to manufacture a thick film electrode for improving the energy density of a battery, a method of applying an electrode slurry to a substrate in the form of a foam and drying it is known. However, since it may not be easy to uniformly impregnate the slurry into the pores of the thick three-dimensional foam substrate, there can be a difficulty in mass production.

According to the present disclosure, a mixture of a polymer powder and an active material can be prepared in the form of a fiber through a dry process that does not use a solvent. After preparing a film by applying a weaving process for manufacturing cloth or fabric, an electrode is manufactured by carbonizing it. The electrode fiber manufactured through the carbonization process according to the present disclosure has high conductivity and is light and can serve as both a substrate and a conductive material in an electrode manufactured in a woven form. In addition, being formed by weaving and including a porous structure, the electrode according to the present disclosure can have excellent electrolyte solution impregnability even though it is a thick film.

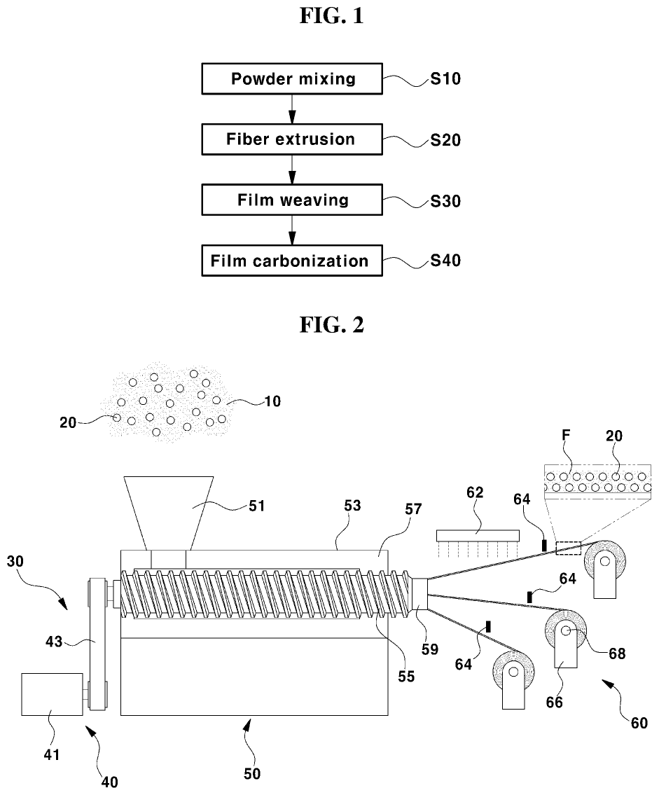

As shown in FIG. 1, the method for manufacturing a battery electrode according to the present disclosure may include powder mixing (S10), fiber extrusion (S20), film weaving (S30), and film carbonization (S40).

FIG. 2 shows the execution of the powder mixing (S10) and fiber extrusion (S20).

First, an extrudable polymer powder 10 and an electrode active material 20 are mixed. The powder 10 is a polymer material capable of fiberization and carbonization. As a non-limiting example, polyacrylonitrile (PAN), polyacrylic acid (PAA), or polytetrafluoroethylene (PTFE) may be selected. According to an implementation of the present disclosure, the mixing ratio of the powder 10 and the active material 20 may be selected within the range of 90:10 to 98:2 in terms of % by weight. The powder 10 and the active material may be mixed with a general mixer having a rotor and a vessel.

A mixture of the powder 10 and the active material 20 may be extruded into a fiber F containing the active material 20 through an extrusion device 30. The temperature of the extrusion device 30 may be set according to the melting point of the polymer powder 10 so that the polymer powder 10 may be melted and extruded in the form of a fiber F containing an active material. For example, when PAN is included, the temperature of the extrusion device 30 is set to 250 to 350 degrees Celsius. According to an implementation of the present disclosure, the extrusion device 30 includes a driver 40, an extruder 50, and a winder 60.

The driver 40 includes a motor 41. The motor 41 provides a driving force to the extruder 50. In addition, the driver 40 further includes a gearbox and a speed reducer 43.

The extruder 50 includes a hopper 51, a barrel 53, a screw 55, a heating jacket 57, and a fiber die 59. A mixture of the powder 10 and the active material 20 is supplied into the extruder 50 through the hopper 51. The mixture of the powder 10 and the active material 20 drawn into the hopper 51 is configured to pass through the screw 55 rotatably mounted in the barrel 53. Having the heating jacket 57, the barrel 53 may heat the mixture of the powder 10 and the active material 20. After passing through the screw 55, the mixture of the powder 10 and the active material 20 is extruded into a fiber F through the fiber die 59 connected to the screw 55. The fiber F to be extruded may have a diameter of 100 to 400 micrometers. In some implementations, the fiber die 59 may be configured in a form capable of obtaining a plurality of fibers F.

The winder 60 is configured to cool the fiber F discharged from the extruder 50 and wind the fiber F in a roll form. To this end, according to an implementation of the present disclosure, the winder 60 may include a cooler 62, a tension controller 64, a winding portion 66, and a fiber reel 68.

The cooler 62 may be an air-cooling or water-cooling type. The cooler 62 is configured to cool the fiber F discharged from the extruder 50 to room temperature. Before the fiber F is wound by the winding portion 66, the tension controller 64 may be disposed in the proceeding path of the fiber F. The tension controller 64 may adjust the tension of the fiber F. The fiber reel 68 is mounted on the winding portion 66. The fiber reel 58 may wind the fiber F around the fiber reel 58 while the winding portion 66 is being driven.

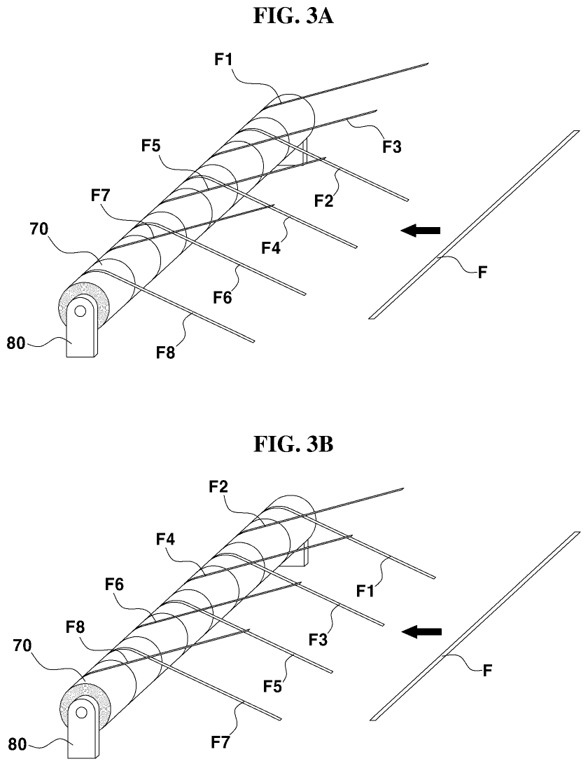

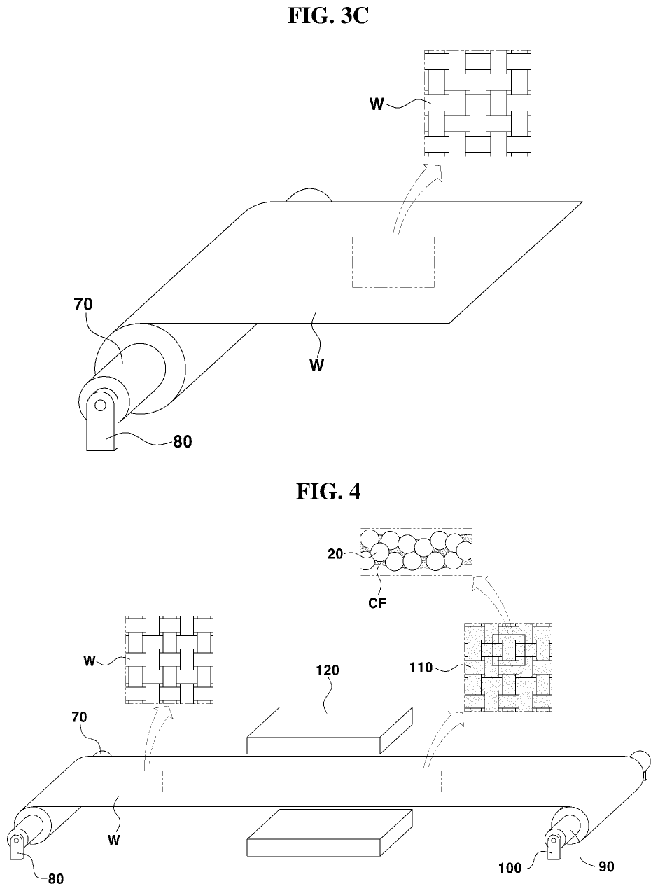

Next, the film is woven (S30). Particularly, a woven film W made into a film by weaving fibers F is obtained. As shown in FIG. 3A, the fiber F wound around the fiber reel 68 is unwound and wound around a film core 70. Fibers F wound around a plurality of fiber reels 68 are fixed to the film core 70 and configured to be wound. To this end, the film core 70 is configured to be rotatable by an actuator 80.

For example, as in the implementation shown in the drawing, when eight fibers F are wound around the film core 70, for weaving, the odd-numbered fibers F1, F3, F5, F7 are tilted upward, whereas the even-numbered fibers F2, F4, F6, F8 are tilted downward. Then the fibers F are inserted in a right angle direction between the fibers F crossed vertically.

Subsequently, as shown in FIG. 3B, the odd-numbered fibers F1, F3, F5, F7 are tilted downward, while the even-numbered fibers F2, F4, F6, F8 are tilted upward. A new fiber F is inserted in the right angle direction between the fibers F crossed vertically. A woven film W is manufactured by repeating this process. As the weaving of the film progresses, the actuator 80 is driven so that the woven film W may be wound around the film core 70. As shown in FIG. 3C, a woven film W in the form of a fabric is obtained.

As shown in FIG. 4, a carbonization process is performed on the woven film W wound around the film core 70. An electrode without a binder may be obtained due to carbonization of the fiber F. The woven film W is configured to be carbonized into a carbonized film 110 through heat treatment as being unwound from the film core 70 and passing through a carbonization device 120. The carbonized film 110 composed of carbonized carbon fibers F and an active material 20 is shown in an enlarged view. In addition, the carbonized film 110 is wound by a roller 90 including a driving device 100 so that manufacturing of the electrode may be completed.

According to the present disclosure, the battery electrode may be manufactured by a dry process rather than a slurry-based wet process. Particularly, the electrode manufactured according to the present disclosure is characterized by having low electrochemical resistance.

After manufacturing fibers containing an electrode active material and carbon, an electrode is manufactured by weaving these fibers. Since the electrode is manufactured in a state in which the polymer is carbonized, it is easy to form an electron conduction channel between active materials in a state without a binder so that there is an advantage in that the electrical resistance is low.

The present disclosure also provides an advantage of lowering ionic resistance since, according to the present disclosure, a structure is formed by weaving the fibers the electrolyte solution can easily penetrate into the gap between the fibers.

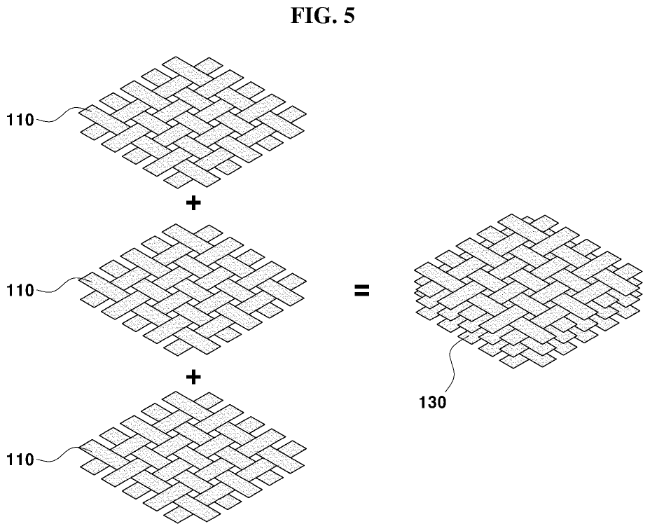

A structure formed by weaving carbon fibers may form a self-supporting film in which a substrate is integrated without a separate metal substrate. When designing electrode film thickening, the assembled electrode 130 may be manufactured by simply stacking the self-supporting films (see FIG. 5).

The present disclosure described above is not limited by the foregoing implementations and the accompanying drawings, and it will be clear to those skilled in the art to which the present disclosure pertains that various substitutions, modifications, and changes are possible within a range that does not deviate from the technical spirit of the present disclosure.

What is claimed is:

1. A method for manufacturing a battery electrode, the method comprising:
forming a mixture of a polymer powder and an active material into a fiber;
weaving the fiber into a woven film; and
carbonizing the woven film.

2. The method of claim 1, wherein forming of the mixture into the fiber is performed by an extrusion device.

3. The method of claim 2, wherein the extrusion device includes:
a driver configured to provide a driving force to the extrusion device; and
an extruder configured to be driven by the driver and configured to extrude the mixture into a fiber.

4. The method of claim 3, wherein the extrusion device further includes a winder configured to wind the extruded fiber.

5. The method of claim 3, wherein the fiber extruded by the extruder is cooled by a cooler.

6. The method of claim 3, wherein the extruder includes:
a barrel;
a hopper through which the mixture is supplied into the barrel;
a screw rotatably disposed within the barrel; and
a fiber die configured so that the mixture passing through the screw is drawn out to a preset diameter.

7. The method of claim 6, wherein the extruder further includes a heating jacket mounted on the barrel, and wherein the temperature of the heating jacket is set to be substantially equal to the melting point of the polymer powder.

8. The method of claim 6, wherein the fiber die is configured to draw out a plurality of fibers.

9. The method of claim 3, wherein the fiber extruded from the extruder is configured to be wound around a fiber reel.

10. The method of claim 1, wherein weaving of the woven film includes:
tilting a first group of a plurality of fibers in a first direction;
tilting a second group of the plurality of fibers in a second direction different from the first direction; and
inserting a first fiber between the tilted first and second groups.

11. The method of claim 10, wherein weaving of the woven film includes steps of:
tilting the first group in the second direction after inserting the first fiber;
tilting the second group in the first direction; and
inserting a second fiber between the tilted first and second groups.

12. The method of claim 11, wherein the plurality of fibers are fixed to a rotatable film core.

13. The method of claim 11, wherein the first fiber and the second fiber are disposed perpendicularly to the first and second groups.

14. The method of claim 1, wherein carbonizing of the woven film is performed through heat treatment.

15. The method of claim 1, wherein an electrode is obtained by stacking a plurality of carbonized films produced by carbonizing the woven film.

16. The method of claim 1, wherein the polymer powder includes one of polyacrylonitrile (PAN), polyacrylic acid (PAA), and polytetrafluoroethylene (PTFE).

17. The method of claim 1, wherein the mixing ratio of the active material and the polymer powder is selected within the range of 90:10 to 98:2 by weight %.

18. A method for manufacturing a battery electrode, the method comprising:
mixing a polymer powder and an active material;
obtaining a fiber by extruding the mixture of the polymer powder and the active material, which has been obtained by mixing;
weaving the fiber into a woven film; and
carbonizing the woven film through a carbonization device.
